(19) United States
(12) Patent Application Publication
(10) Pub. No.: US 2025/0284001 A1
(43) Pub. Date: Sep. 11, 2025

(54) SYSTEMS AND METHODS TO DETECT IMPROPER MEDIA LOADING

(71) Applicant: Hand Held Products, Inc., Charlotte, NC (US)

(72) Inventors: Sze Ping Ching, Singapore (SG); Cheng Khoon Ng, Singapore (SG); Phek Thong Lee, Singapore (SG)

(21) Appl. No.: 18/598,578

(22) Filed: Mar. 7, 2024

(51) Int. Cl. G01S 15/08; G01S 15/86; H04N 1/00

(52) U.S. Cl. CPC G01S 15/08; G01S 15/86; H04N 1/00689; H04N 1/00694

(57) ABSTRACT

A system to detect improper media loading is disclosed. The system comprises at least one media sensor installed within a printer and configured to determine information related to an angle of at least one arm that rotates in a predefined path upon receiving a media within printer, or a distance between media and at least one media sensor. Further, at least one processor is communicatively coupled to the at least one media sensor and configured to receive determined information related to angle or distance between media and at least one media sensor, from the at least one media sensor. The at least one processor compares the determined information with a predefined threshold value range associated with angle of at least one arm or distance. Thereafter, the at least one processor determines improper loading of the media within the printer based at least on the comparison.

### TECHNOLOGICAL FIELD

Example embodiments of the present disclosure relate generally to printers, and more particularly, to a system and method to detect improper media loading in a printer.

### BACKGROUND

Printers play an indispensable role in facilitating efficient document processing. Lack of a reliable system to confirm proper media loading within a printer is a critical issue existing in the printers. Moreover, users are left without any feedback mechanism to ascertain whether the media, such as paper or other printing materials, is loaded correctly into the printer. Absence of such feedback mechanism has significant consequences, ranging from inconvenient paper jams to the impairment of essential media low detection features. Therefore, users are left to navigate through the process of improper media loading without real-time confirmation, leading to a lot of issues. Also, the improper loading of media is a primary cause behind frequent paper jams that disrupts workflow. Such improper loading of media not only disrupts printing tasks but also risks damage to the hardware of the printer and compromises the overall user experience.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY OF THE INVENTION

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an example embodiment, a system is disclosed. The system comprises at least one media sensor installed within a printer. The at least one media sensor is configured to determine information related to an angle of at least one arm that rotates in a predefined path upon receiving a media within the printer, or a distance between the media and the at least one media sensor. Further, at least one processor is communicatively coupled to the at least one media sensor. The at least one processor is configured to receive the determined information related to the angle or the distance between the media and the at least one media sensor, from the at least one media sensor. Further, the at least one processor is configured to compare the determined information with a predefined threshold value range associated with the angle of the at least one arm or the distance between the media and the at least one media sensor. Thereafter, the at least one processor is configured to determine improper loading of the media within the printer based at least on the comparison.

In some embodiments, the at least one media sensor comprises at least one of an angular sensor or a proximity sensor. In some embodiments, the angular sensor has the at least one arm, and is configured to determine the angle of the at least one arm. In some embodiments, the proximity sensor emits one or more rays and receives reflected one or more rays from the media to determine the distance between the proximity sensor and the media. In some embodiments, the one or more rays corresponds to at least one of one or more infrared waves (IR) or ultrasonic sound waves (UV).

In some embodiments, the at least one arm of the angular sensor is positioned along a surface of the media, and the proximity sensor is positioned at a base of the printer and underneath to the media. The predefined path of the at least one arm defines a first end and a second end. In some embodiments, the at least one arm positioned at the first end of the predefined path indicates an empty media condition and the at least one arm positioned at the second end of the predefined path indicates a full media condition.

In some embodiments, the media pushes the at least one arm towards the second end of the predefined path that corresponds to the proper loading of the media within the printer. In some embodiments, the determined angle of the at least one arm below or above the predefined threshold value range corresponds to the improper loading of the media within the printer. In some embodiments, the determined distance between the media and the proximity sensor below or above the predefined threshold value range corresponds to the improper loading of the media within the printer.

In some embodiments, the at least one processor is configured to generate one or more notifications upon determining the improper loading of the media within the printer. In some embodiments, the one or more notifications are displayed to a user over a display device communicatively coupled to the at least one processor.

In another example embodiment, a method is disclosed. The method comprises steps of determining, via at least one media sensor installed within a printer, information related to an angle of at least one arm that rotates in a predefined path upon receiving a media within the printer, or a distance between the media and the at least one media sensor; receiving, via at least one processor, the determined information related to the angle or the distance between the media and the at least one media sensor, from the at least one media sensor; comparing, via the at least one processor, the determined information with a predefined threshold value range associated with the angle of the at least one arm or the distance between the media and the at least one media sensor; and determining, via the at least one processor, improper loading of the media within the printer based at least on the comparison.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a block diagram showing a system to detect improper loading of a media in a printer in accordance with an example embodiment of the present disclosure;

FIGS. 2A-2B illustrate a media holder of a printer in accordance with an example embodiment of the present disclosure;

FIG. 2C illustrates a full media condition detected by an angular sensor in accordance with an example embodiment of the present disclosure;

FIGS. 2D-2E illustrate a media hanger at each side of the media and each media hanger having the angular sensor in accordance with an example embodiment of the present disclosure;

FIG. 3 illustrates a proximity sensor integrated within the media holder of the printer in accordance with an example embodiment of the present disclosure;

FIG. 4 illustrates a display device of the system in accordance with an example embodiment of the present disclosure; and

FIG. 5 illustrates a flowchart showing steps of a method to detect improper loading of a media in accordance with an example embodiment of the present disclosure.

### DETAILED DESCRIPTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of systems and methods to detect improper loading of media. Embodiments may be configured to determine improper loading of a media within a media holder of the printer. Embodiments may be configured to allow movement of at least one arm of an angular sensor to move from one end to other end upon loading or unloading of the media within the media holder. Embodiments may be configured to determine an angle of the at least one arm of an angular sensor upon loading of the media within the media holder. Embodiments may be configured to determine distance between the media and a proximity sensor installed within the media holder upon loading of the media within the media holder. Embodiments may be configured to compare the determine angle and the distance with a predefined threshold value range to determine improper loading or unloading of the media within the media holder.

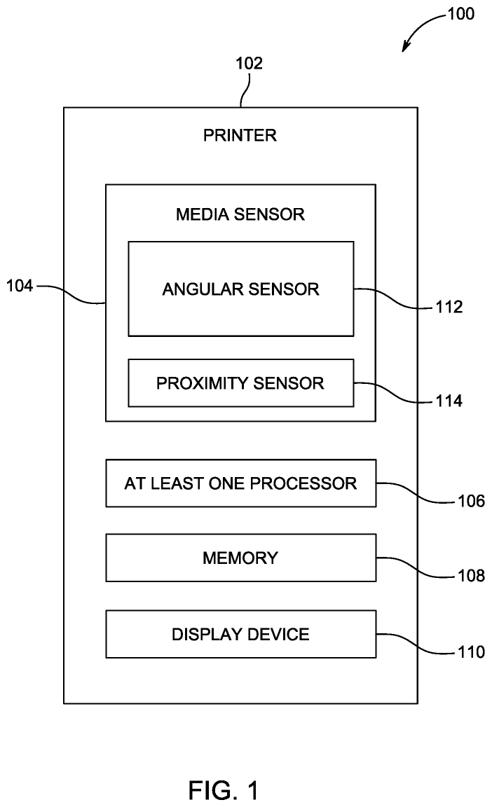

FIG. 1 illustrates a block diagram showing a system 100 to detect improper loading of media in a printer 102, in accordance with an example embodiment of the present disclosure. The system 100 may comprise at least one media sensor 104, at least one processor 106, a memory 108, and a display device 110.

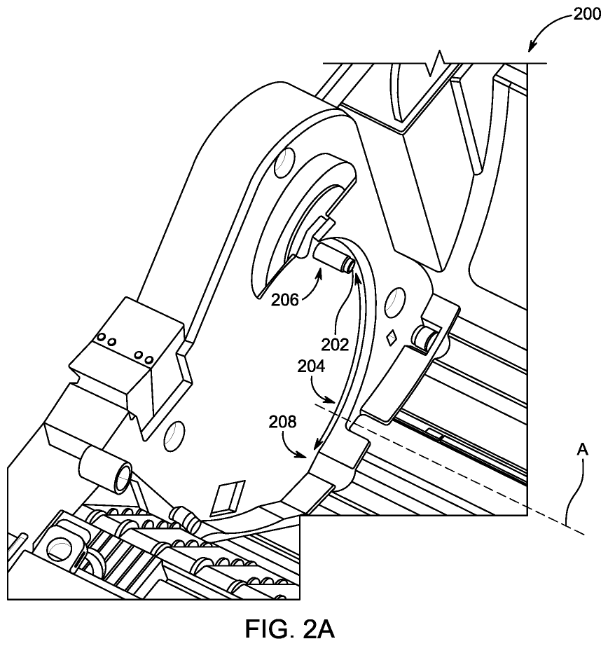

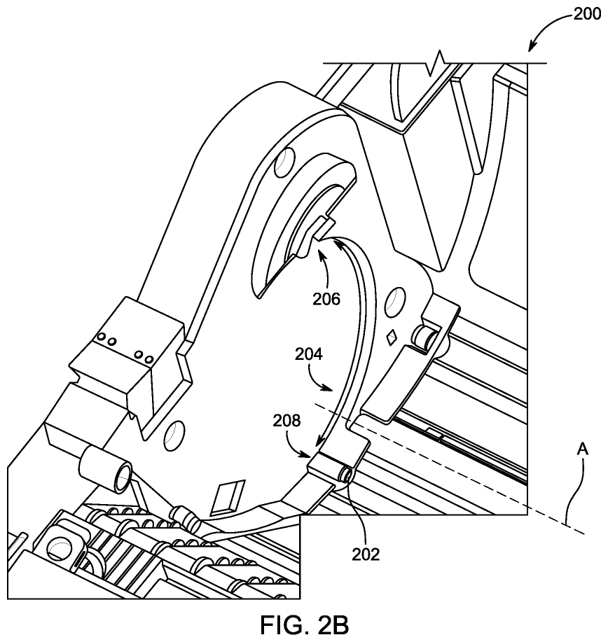

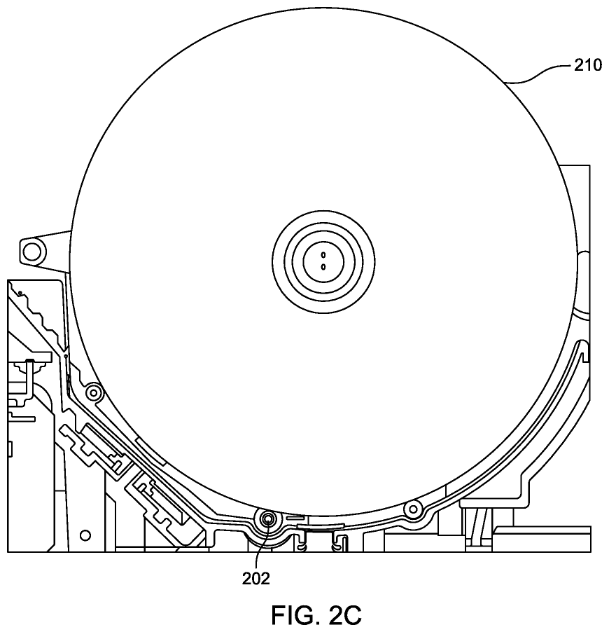

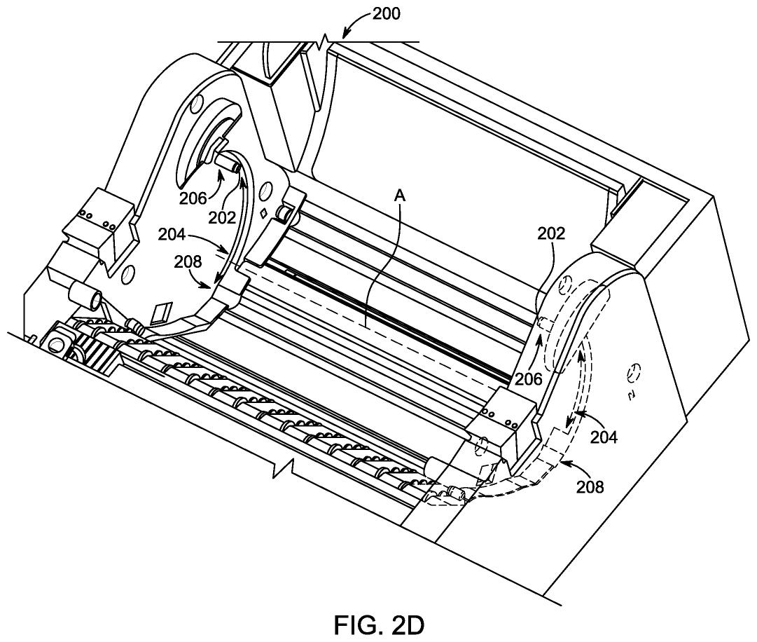

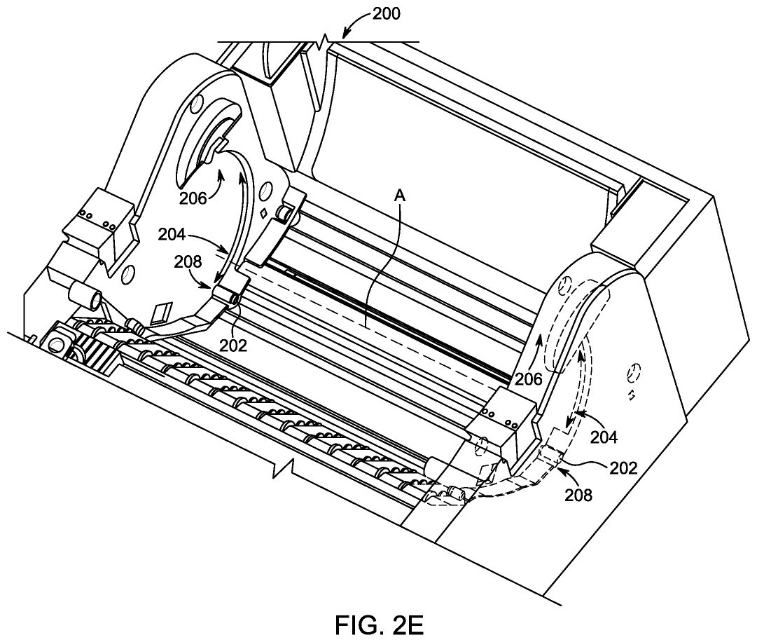

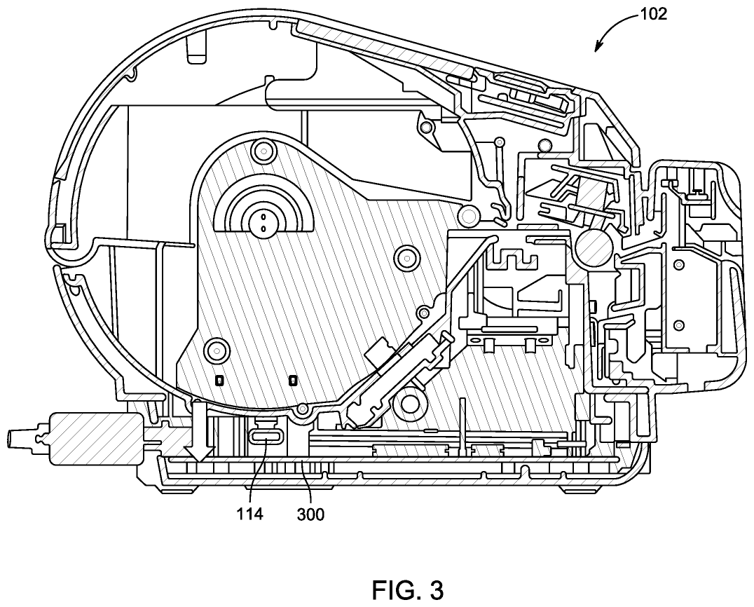

In some embodiments, the at least one media sensor 104 may be installed within the printer 102. Further, the at least one media sensor 104 may comprise at least one of an angular sensor 112 having at least one arm (not shown) or a proximity sensor 114. Further, the at least one media sensor 104 may be configured to determine information related to improper media loading within the printer 102. In some example embodiments, the angular sensor 112 may be configured to determine the angle of the at least one arm that may rotate in the predefined path. Further, the at least one media sensor 104 may be configured to determine a distance between the media (not shown) and the at least one media sensor 104. In some other example embodiments, the proximity sensor 114 may be configured to determine the distance between the media and the proximity sensor 114. The detailed description of the at least one media sensor 104 is described in conjunction with FIGS. 2A-3.

As illustrated in FIG. 1, the system 100 may further comprise the at least one processor 106. The at least one processor 106 may be communicatively coupled to the at least one media sensor 104. Further, the at least one processor 106 may be configured to receive the determined information related to the angle or the distance between the media and the at least one media sensor 104, from the at least one media sensor 104. Further, the at least one processor 106 may be configured to compare the determined information with a predefined threshold value range associated with the angle of the at least one arm or the distance between the media and the at least one media sensor 104. Further, the at least one processor 106 may be configured to determine improper loading of the media within the printer 102 based at least on the comparison.

In various example embodiments, the at least one processor 106 may include suitable logic, circuitry, and/or interfaces that are operable to execute one or more instructions stored in the memory 108 to perform predetermined operations. In some embodiments, the at least one processor 106 may be configured to decode and execute any instructions received from one or more other electronic devices or server(s). The at least one processor 106 may be configured to execute one or more computer-readable program instructions, such as program instructions to carry out any of the functions described in this description. Further, the at least one processor 106 may be implemented using one or more processor technologies known in the art. Examples of the processor include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

Further, the memory 108 may store a set of instructions and data. In some embodiments, the memory 108 may include the one or more instructions that are executable by the at least one processor 106 to perform specific operations. In some embodiments, the memory 108 may be configured to store the received determined information related to the angle or the distance between the media and the at least one media sensor 104, from the at least one media sensor 104. Further, the memory 108 may be configured to store the compared values of the determined information with the predefined threshold value range associated with the angle of the at least one arm or the distance between the media and the at least one media sensor 104. It is apparent to a person with ordinary skill in the art that the one or more instructions stored in the memory 108 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

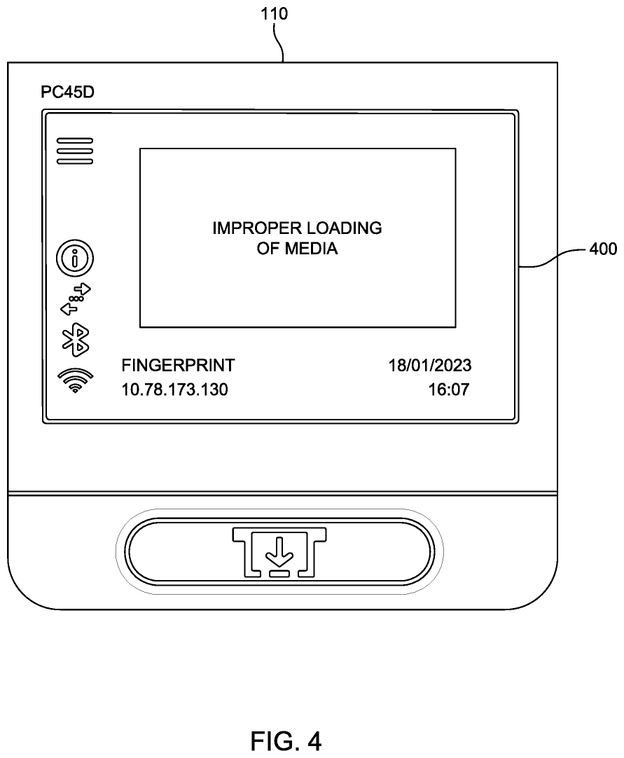

In some embodiments, the at least one processor 106 may be configured to generate one or more signals to cause one or more notifications upon determining the improper loading of the media 210 (FIG. 2B) within the printer 102. Further, the one or more notifications may be displayed for a user over the display device 110. The display device 110 may be communicatively coupled to the at least one processor 106. The display device 110 is described in greater detail in conjunction with FIG. 4.

It will be apparent that the above-mentioned components of the system 100 have been provided only for illustration purposes. In another embodiment, the system 100 may include other components such as a controller unit, a microprocessor unit (MPU), a microcontroller unit (MCU), etc. without departing from the scope of the disclosure.

FIGS. 2A-2B illustrate at least one media holder 200 of the printer 102, in accordance with an example embodiment of the present disclosure. FIG. 2C illustrates a full media condition detected by the angular sensor 112, in accordance with an example embodiment of the present disclosure. FIGS. 2A-2C are described in conjunction with FIG. 1.

The at least one media holder 200 may ensure proper alignment of the media 210 as the media 210 passes through various components (not shown) of the printer 102. Further, the at least one media holder 200 may ensure smooth movement of the media 210 as the media 210 passes through the various components of the printer 102. In some embodiments, the at least one media holder 200 may comprise the angular sensor 112. Further, the angular sensor 112 may include at least one arm 202. The at least one arm 202 of the angular sensor 112 may be positioned along a surface of the media 210. As discussed earlier, the at least one media sensor 104, e.g., the angular sensor 112, may be configured to determine information related to the angle of the at least one arm 202 that rotates in a predefined path 204 upon receiving the media 210 within the printer 102. Further, the angular sensor 112 may measure angular rotation of the at least one arm 202. Thereafter, the angular sensor 112 may convert the measured angular rotation into a scaled electrical signal in real time to determine information related to the angle of the at least one arm 202. In some embodiments, the media 210 may include printing media such as paper, labels, or other printable materials known in the art.

Further, the predefined path 204 of the at least one arm 202 may define a first end 206 and a second end 208. The at least one arm 202 may be positioned between the first end 206 and the second end 208. In some embodiments, the at least one arm 202 positioned at the first end 206 may indicate an empty media condition. In some example embodiments, the empty media condition may correspond to a condition where the media of the printer 102 is completely used. In some other embodiments, the at least one arm 202 positioned at the second end 208 of the predefined path 204 may indicate a full media condition. In some example embodiments, the full media condition may correspond to a condition where a new media is loaded within the printer 102.

In some embodiments, while positioning the at least one arm 202 between the first end 206 and the second end 208 and along the predetermined path 204, the angle of the at least one arm 202 may be determined with respect to a horizontally-extending axis A that the at least one arm 202 rotates around. Further, the angle of the at least one arm 202 may be directly proportional to diameter of the media 210, e.g., the angle may change when the diameter of the media may change. In some embodiments, the diameter of the media 210 may also correspond to amount of media remaining on the media hanger, e.g. as the media 210 gets used by the user, the diameter of the media 210 may also reduce. In some embodiments, improper loading of media may be detected based on a predefined threshold value range of the angle. In some embodiments, the predefined threshold value range may depend upon diameter of the media in order to convert the electrical signal reading to the diameter of the media. Further, if the electrical signal reading value is below or above the predefined threshold value range or the diameter of the media, then improper loading of the media may be indicated. In one example embodiment, the predefined threshold value range may include a range of 0° to 1°. Further, the predefined threshold range value may depend upon the design of the at least one arm 202 of the angular sensor 112. In some example embodiments, the determined angle of the at least one arm 202 below or above the predefined threshold value range may correspond to the improper loading of the media within the printer 102.

In some embodiments, a media 210 as shown in FIG. 2B, may be placed within the at least one media holder 200 of the printer 102. Further, the media 210 may be resting over a media hanger. The media hanger may comprise one or more adjustable brackets or one or more arms that may be designed to secure the media 210 in a fixed position during the printing operation. The media 210 when placed within the at least one media holder 200, may press the at least one arm 202. The pressing of the at least one arm 202 may reposition the at least one arm 202 from the first end 206 of the predefined path 204 to the second end 208 of the predefined path 204. In some embodiments, upon removing the media 210 from the media holder, the at least one arm 202 may retract back from the second end 208 of the predefined path 204 to the first end 206 of the predefined path 204. In some exemplary embodiments, the at least one arm 202 may be integrated with a biasing member, such as a spring (not shown). The biasing member may be configured to retract the at least one arm 202 from the second end 208 of the predefined path 204 to the first end 206 of the predefined path 204 upon unloading the media 210. In some embodiments, the determined angle of the at least one arm 202 below or above the predefined threshold value range may correspond to the improper loading of the media 210 within the printer 102.

FIGS. 2D-2E illustrate a portion of a printer 102, in accordance with an example embodiment of the present disclosure. FIGS. 2D-2E are described in conjunction with FIGS. 2A-2C.

In some embodiments, each side of the media 210 may be installed with the media hanger. Further, the printer 102 may include two or more angular sensors 112, at least one angular sensor 112 may be positioned on an opposite internal side of the printer 102 as at least one other angular sensor 112. In some embodiments, each angular sensor 112 may include at least one arm 202 positioned along the surface of the media 210. Each angular sensor 112 may be configured to determine information related to the angle of the at least one arm 202 that rotates in the respective predefined path 204 upon receiving the media 210 within the printer 102. Further, each angular sensor 112 may measure angular rotation of the at least one arm 202. In some embodiments, upon placing the media 210 within the media hanger, each arm of the angular 112 sensor at each side of the media may rotate in the respective predefined path 204 as shown in FIG. 2E.

Further, the predefined path 204 of each arm 202 may define the first end 206 and the second end 208. Each arm 202 may be positioned between the respective first end 206 and the second end 208. In some embodiments, each arm 202 positioned at the first end 206 may indicate an empty media condition that correspond to the condition where the media of the printer 102 is completely used. In some other embodiments, each arm 202 positioned at the second end 208 of the predefined path 204 may indicate the full media condition, which may correspond to the condition where the new media is loaded within the printer 102.

In some embodiments, improper loading of media 210 may be detected based on comparing the angle of rotation of the at least one arm 202 of the angular sensor 112 at each side of the media 210. For example, improper loading of media 210 may be detected by comparing the angle of rotation of at least one angular sensor 112 that is positioned on a first internal side of the printer 102 to the angle of rotation of at least one other angular sensor 112 that is positioned on an opposite second internal side of the printer 102. In some embodiments, any difference between the angle of rotation of the at least one arm 202 of the angular sensor 112 at each side of the media may correspond to improper loading of the media 210. In some embodiments, the difference between the angle of rotation of each of the at least one arm 202 above a threshold value may correspond to the improper loading of the media 210. Further, the difference between the angle of rotation of each of the at least one arm 202 below a threshold value may correspond to the proper loading of the media 210. In one example embodiment, the predefined threshold value range may include a range of 0° to 1°. Further, the predefined threshold range value may depend upon the design of the at least one arm 202 of the angular sensor 112.

FIG. 3 illustrates the proximity sensor 114 integrated within the at least one media holder 200 of the printer 102, in accordance with an example embodiment of the present disclosure. FIG. 3 is described in conjunction with FIGS. 1-2B.

The proximity sensor 114 may be positioned at a base 300 of the printer 102 and underneath to the media 210. In some embodiments, the proximity sensor 114 may correspond to at least one of an electromagnetic filed sensor, capacitive proximity sensor, or a photoelectric proximity sensor. In some embodiments, the proximity sensor 114 may emit one or more rays. Further, the one or more rays may correspond to at least one of one or more electromagnetic fields or one or more electromagnetic radiation beams, for example, one or more infrared (IR) rays, ultrasonic sound waves (UV). The emitted one or more rays may hit the media 210 and may be reflected to the proximity sensor 114. Further, the proximity sensor 114 may receive reflected one or more rays from the media 210. In some embodiments, based on the received reflected one or more rays, a distance between the proximity sensor 114 and the media 210 may be determined. Further, there may be a predefined threshold value range of the distance, below or above which, improper media loading may be detected. In some embodiments, the predetermined threshold value range may depend on the design of the printer 102. In one example embodiment, the predefined threshold value range of the printer 102 of a specific design may include a range of 2 centimeters (cm) to 5 cm. In some embodiments, the determined distance between the media 210 and the proximity sensor 114 below or above the predefined threshold value range may correspond to the improper loading of the media within the printer 102.

In some embodiments, both the angular sensor 112 and the proximity sensor 114 may be used as a combination. The angular sensor 112 may ensure that the media 210 is placed at the at least one media holder 200 through the at least one arm 202. Further, the proximity sensor 114 may ensure that the media may not be touching the base 300 of the printer 102.

In some example embodiments, the proximity sensor 114 may correspond to the ultrasonic proximity sensor. Further, the ultrasonic proximity sensor may be configured to emit a high pitch sound. The emitted high pitch sound may hit the media 210 and reflect back to the ultrasonic proximity sensor. Further, a distance between the ultrasonic proximity sensor and the media 210 may be determined. The distance may be determined based at least on time taken by the high pitch sound to reflect back to the ultrasonic proximity sensor. Further, based at least on the determined distance, improper media loading may be detected. In other example embodiments, the proximity sensor 114 may correspond to at least one of a capacitive proximity sensor, a photoelectric proximity sensor, or any other proximity sensor known in the art.

In some example embodiments, the printer 102 may comprise at least two proximity sensors 114. Both proximity sensors 114 may be placed at a predefined distance from each other to detect the distance between each proximity sensor 114 and the media 210. Further, the distance between the proximity sensor 114 and the media 210 may be compared with the distance between at least one other proximity sensor 114 and the media 210. Based on the comparison, any difference in the distance may indicate misloading of the media 210.

FIG. 4 illustrates the display device 110 of the system 100, in accordance with an example embodiment of the present disclosure. FIG. 4 is described in conjunction with FIGS. 1-3.

The display device 110 may include a user interface (UI) 400 for interacting with the user to display one or more notifications to the user. In some embodiments, the at least one processor 106 may generate one or more signals for the display device 110 to display the one or more notifications to the user. The at least one processor 106 may be configured to generate one or more signals upon determining the improper unloading of the media 210. In some example embodiments, upon detecting the determined angle of the at least one arm 202 below or above the predefined threshold value range or distance between the media 210 and the proximity sensor 114 below or above the predefined threshold value, the UI 400 may display “IMPROPER LOADING OF MEDIA” to the user, as shown in FIG. 4.

Further, the UI 400 may receive the one or more commands from the user. Further, the UI 400 may provide an output to the user based on the received one or more commands. In one example embodiment, the user may provide a command to send a notification to a remote device such as a smartphone, when the improper loading of the media is detected. Thereafter, the UI 400 may display “NOTIFICATION SENT TO USER”. In another example embodiment, the user may provide a command to send a notification to determine the angle of the at least one arm 202 after a time interval of 30 seconds(s) and display the determined angle of the at least one arm 202 to the user. In yet another example embodiment, the user may provide a command to update the angle of the at least one arm 202 to the diameter of the media and display the diameter of the media to the user.

In some embodiments, the UI 400 may provide current date and time when the media 210 is loaded in the printer 102. Further, the UI 400 may perform both the aforementioned actions simultaneously. The UI 400 may either be a Command Line Interface (CLI), Graphical User interface (GUI), or a voice interface. Further, the user may connect to the system 100 via the UI 400 using one or more communication protocols. The one or more communication protocols may include Bluetooth, 4G, 5G, Wi-Fi, or any other communication protocol known in the art.

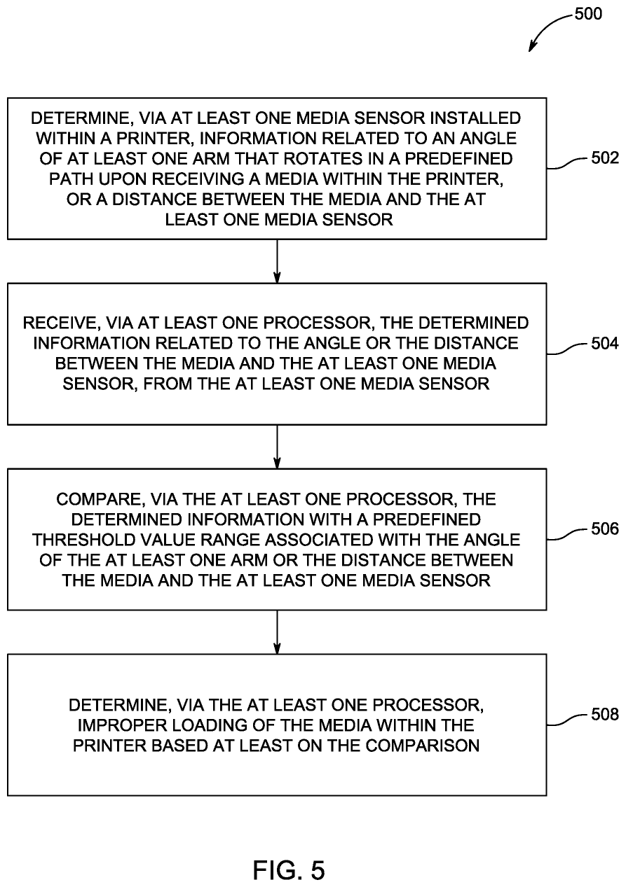

FIG. 5 illustrates a flowchart showing steps of a method 500 of the system 100 to detect improper loading of media, in accordance with an example embodiment of the present disclosure. FIG. 6 is described in conjunction with FIGS. 1-4.

At operation 502, the information related to the angle of the at least one arm 202 that rotates in the predefined path 204 upon receiving the media 210 within the printer 102, or the distance between the media 210 and the at least one media sensor 104 may be determined, via the at least one media sensor 104 installed within the printer 102. In some embodiments, the at least one media sensor 104 may comprise at least one of the angular sensor 112 or the proximity sensor 114.

In some embodiments, the angular sensor 112 may have the at least one arm 202, and may be configured to determine the angle of the at least one arm 202. In some embodiments, the proximity sensor 114 may emit one or more rays and may receive reflected one or more rays from the media 210 to determine the distance between the proximity sensor 114 and the media 210. Further, the one or more rays may correspond to at least one of one or more electromagnetic fields or one or more electromagnetic radiation beams, for example, one or more infrared (IR) rays or ultrasonic sound waves (UV). In some embodiments, the predefined path 204 of the at least one arm 202 may define the first end 206 and the second end 208. Further, the at least one arm 202 positioned at the first end 206 of the predefined path 204 may indicate an empty media condition and the at least one arm 202 positioned in the second end 208 of the predefined path 204 may indicate a full media condition. In some embodiments, the media 210 may push the at least one arm 202 towards the second end 208 of the predefined path 204 that may correspond to the proper loading of the media 210 within the printer 102. In some embodiments, the determined information may be converted to diameter value of the media 210.

For example, a user opens a cover of the printer 102 to load a paper. The at least one media sensor 104 determines information related to the angle of the at least one arm 202 that rotates in a predefined path 204 upon receiving the paper within the printer 102, or the distance between the paper and the at least one media sensor 104. The determined information obtained is 15° or 23 cm. The determined information is converted to diameter value of the paper.

At operation 504, the determined information related to the angle or the distance between the media 210 and the at least one media sensor 104 may be received, via the at least one processor 106, from the at least one media sensor 104.

At operation 506, the determined information may be compared, via the at least one processor 106, with the predefined threshold value range associated with the angle of the at least one arm 202 or the distance between the media 210 and the at least one media sensor 104. For example, the determined information of 15° or 23 cm is compared with a predefined threshold value range of 16-23° or 25 cm-30 cm.

At operation 508, improper loading of the media 210 within the printer 102 may be determined, via the at least one processor 106, based at least on the comparison. In some embodiments, the determined angle of the at least one arm 202 below or above the predefined threshold value range may correspond to the improper loading of the media 210 within the printer 102. In some embodiments, the determined distance between the media 210 and the proximity sensor 114 below or above the predefined threshold value range may correspond to the improper loading of the media 210 within the printer 102. For example, based on the comparison since determined information of 15° or 23 cm is below the predefined threshold value range of 16-23° or 25 cm-30 cm, therefore improper loading of the media is determined.

In some embodiments, the at least one processor 106 generates one or more notifications upon determining the improper loading of the media 210 within the printer 102. Further, the at least one display device 110 communicatively coupled to the at least one processor 106 may display the one or more notifications to the user.

In some embodiments, the system 100 may further generate, via the at least one processor 106, one or more notifications upon determining the improper loading of the media 210 within the printer 102. Further, the system 100 may display, via the at least one display device 110 the generated one or more notifications to the user. For example, “IMPROPER LOADING OF THE MEDIA” on the display device 110 when improper loading of the media is detected.

It will be appreciated that the method 500 may be implemented by the one or more embodiments disclosed herein, which may be combined or modified as desired or needed. Additionally, the steps in the method 500 may be modified, changed in order, performed differently, performed sequentially, concurrently or simultaneously, or otherwise modified as desired or needed.

In some embodiments, the system 100 and the method 500 prevents errors related to improper media loading by using proximity or media sensors. In some alternate embodiments, the introduction of the addition of the at least one media sensor further underscores its economic benefits, translating into substantial savings. In some embodiments, the system 100 may have a compact design that optimizes space utilization and enhances overall efficiency, making it a versatile and cost-effective solution for various applications. Additionally, the system 100 provide automated detection and display of media information to save time and resources by eliminating the need for manual configuration. Further, proper media loading detection by the system 100 and the method 500 minimizes the chances of misprints or errors, reducing material waste.

Embodiments may ensure that correct type and size of the media are loaded, preventing issues such as misalignment, smudging, or poor print quality. Embodiments may protect the printer from potential damage that may occur when improper media, such as excessively thick or incompatible materials, is loaded in the printer. Embodiments may provide real-time monitoring capability to ensure proper loading of the media inside the printer. Additionally, embodiments may be integrated into various types of printing equipment, such as laser printers, 3D printers, thermal printers, radio frequency identification (RFID) printers, etc., providing robust and reliable improper media loading detection solutions to improve efficiency, and maintain the longevity of the printing equipment.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
at least one media sensor installed within a printer, the at least one media sensor configured to determine information related to an angle of at least one arm that rotates in a predefined path upon receiving a media within the printer, or a distance between the media and the at least one media sensor; and
at least one processor communicatively coupled to the at least one media sensor, the at least one processor configured to:
receive the determined information related to the angle or the distance between the media and the at least one media sensor, from the at least one media sensor;
compare the determined information with a predefined threshold value range associated with the angle of the at least one arm or the distance between the media and the at least one media sensor; and
determine improper loading of the media within the printer based at least on the comparison.

2. The system of claim 1, wherein the at least one media sensor comprises at least one of an angular sensor or a proximity sensor.

3. The system of claim 2, wherein the angular sensor has the at least one arm, and is configured to determine the angle of the at least one arm.

4. The system of claim 2, wherein the proximity sensor emits one or more rays and receives reflected one or more rays from the media to determine the distance between the proximity sensor and the media, and wherein the one or more rays corresponds to at least one of one or more infrared waves (IR) or ultrasonic sound waves (UV).

5. The system of claim 3, wherein the at least one arm of the angular sensor is positioned along a surface of the media, and the proximity sensor is positioned at a base of the printer and underneath to the media.

6. The system of claim 1, wherein the predefined path of the at least one arm defines a first end and a second end, and wherein the at least one arm positioned at the first end of the predefined path indicates an empty media condition and the at least one arm positioned at the second end of the predefined path indicates a full media condition.

7. The system of claim 6, wherein the media pushes the at least one arm towards the second end of the predefined path that corresponds to the proper loading of the media within the printer.

8. The system of claim 1, wherein the determined angle of the at least one arm below or above the predefined threshold value range corresponds to the improper loading of the media within the printer.

9. The system of claim 4, wherein the determined distance between the media and the proximity sensor below or above the predefined threshold value range corresponds to the improper loading of the media within the printer.

10. The system of claim 1, wherein the at least one processor is configured to generate one or more notifications upon determining the improper loading of the media within the printer.

11. The system of claim 10, wherein the one or more notifications are displayed to a user over a display device communicatively coupled to the at least one processor.

12. A method comprising:
determining, via at least one media sensor installed within a printer, information related to an angle of at least one arm that rotates in a predefined path upon receiving a media within the printer, or a distance between the media and the at least one media sensor;
receiving, via at least one processor, the determined information related to the angle or the distance between the media and the at least one media sensor, from the at least one media sensor;
comparing, via the at least one processor, the determined information with a predefined threshold value range associated with the angle of the at least one arm or the distance between the media and the at least one media sensor; and
determining, via the at least one processor, improper loading of the media within the printer based at least on the comparison.

13. The method of claim 12, wherein the at least one media sensor comprises at least one of an angular sensor or a proximity sensor.

14. The method of claim 13, wherein the angular sensor has the at least one arm, and is configured to determine the angle of the at least one arm.

15. The method of claim 13, wherein the proximity sensor emits one or more rays and receives reflected one or more rays from the media to determine the distance between the proximity sensor and the media, and wherein the one or more rays corresponds to at least one of one or more infrared waves (IR) or ultrasonic sound waves (UV).

16. The method of claim 12, wherein the predefined path of the at least one arm defines a first end and a second end, wherein the at least one arm positioned at the first end of the predefined path indicates an empty media condition and the at least one arm positioned in the second end of the predefined path indicates a full media condition.

17. The method of claim 16, wherein the media pushes the at least one arm towards the second end of the predefined path that corresponds to the proper loading of the media within the printer.

18. The method of claim 12, wherein the determined angle of the at least one arm below or above the predefined threshold value range corresponds to the improper loading of the media within the printer.

19. The method of claim 15, wherein the determined distance between the media and the proximity sensor below or above the predefined threshold value range, corresponds to the improper loading of the media within the printer.

20. The method of claim 12, further comprising:
generating, via the at least one processor, one or more notifications upon determining the improper loading of the media within the printer, and
displaying, via at least one display device communicatively coupled to the at least one processor, the one or more notifications to a user.
